(19) United States
(12) Patent Application Publication
(10) Pub. No.: US 2010/0241260 A1
(43) Pub. Date: Sep. 23, 2010

(54) INDUSTRIAL COMMUNICATION SYSTEM AND METHOD

(75) Inventors: Velibor Kilibarda, Birmingham, MI (US); David Wang, Northville, MI (US)

Correspondence Address: YOUNG BASILE, 3001 WEST BIG BEAVER ROAD, SUITE 624, TROY, MI, 48084, US

(73) Assignee: Comau, Inc., Southfield, MI (US)

(21) Appl. No.: 12/725,635

(22) Filed: Mar. 17, 2010

Related U.S. Application Data
(60) Provisional application No. 61/160,893, filed on Mar. 17, 2009.
(60) Provisional application No. 61/294,265, filed on Jan. 12, 2010.

(51) Int. Cl. G05B 19/05; G05B 19/04

(52) U.S. Cl. 700/95; 700/248; 901/30

(57) ABSTRACT

Disclosed here is a method for controlling at least one industrial device using a remote infrastructure environment having at least one computing resource and a cloud communication network. The method includes establishing communication between the at least one industrial device and the remote infrastructure environment, transmitting data from the at least one computing resource using the cloud communication network to a plant communication network, the at least one industrial device configured to perform at least one predetermined function in response to at least a portion of the transmitted data and receiving data from the at least one industrial device by the at least one computing resource using the cloud communication network, the received data generated in response to performance of the at least one predetermined function.

### CROSS-REFERENCE TO RELATED APPLICATIONS

This application claims priority to U.S. Provisional Patent Application No. 61/160,893, filed Mar. 17, 2009 and claims priority to U.S. Provisional Patent Application No. 61/294,265, filed Jan. 10, 2010, both of which are hereby incorporated by reference in their entirety.

### TECHNICAL FIELD

The present invention generally pertains to systems and methods for industrial communication and more specifically, industrial communication through a remote infrastructure environment.

### BACKGROUND

An assembly line in a manufacturing facility typically includes multiple automated robots. The robots can include connectors on ends of their wrists for receiving respective end effectors, and each robot is in communication with a respective control system that controls the operation of the robot and the end effector. Each control system typically includes a programmable logic controller (PLC), which is programmed to control its robot and end effector to perform a specific operation or set of operations. For example, a control system coupled to a robot carrying a welding end effector may be programmed to control the robot to move the welding end effector into a specific position and to actuate the welding end effector once in the specific position. In this example, the control system can be programmed to control movement of the robot in three dimensions and rotation of the robot in up to three dimensions, as well as actuation of the end effector.

However, the assembly line may be reconfigured in order to, for example, accommodate a different type of work piece. Reconfiguring the assembly line typically requires that the operations performed by many of the robots and end effectors be changed. As a result, many of the control systems must be re-programmed to control their respective robots and end effectors in a different manner. For example, if a welding end effector is removed from a robot and replaced with clamping end effector, the control system must be updated to properly control the robot and clamping end effector. As another example, the control system may need to be reprogrammed if operation performed by the end effector differs in any way, such as in duration or location, even if the end effector remains the same.

Apart from reprogramming, control systems employing these on-site PLCs (i.e. PLCs physically located at the manufacturing facility) typically, for example, increase the costs of the manufacturing facility. Further, as discussed previously, reprogramming and/or performing maintenance on each PLC can be time-consuming and can reduce the efficiency of the assembly line.

### SUMMARY

Embodiments of a method for controlling at least one industrial device using a remote infrastructure environment having at least one computing resource and a cloud communication network are disclosed herein. In one such embodiment, the method includes establishing communication between the at least one industrial device and the remote infrastructure environment and transmitting data from the at least one computing resource to a plant communication network using the cloud communication network. The at least one industrial device is configured to perform at least one predetermined function in response to at least a portion of the transmitted data. The method also includes receiving data by the at least one computing resource from the at least one industrial device using the cloud communication network. The received data is generated in response to performance of the at least one predetermined function.

Embodiments of a method for communicating with at least one industrial device using a remote infrastructure environment having at least one computing resource and a cloud communication network. The method includes establishing communication between the at least one industrial device and the remote infrastructure environment and receiving data by the at least one industrial device from the at least one computing resource using a plant communication network. Further, the method includes performing at least one predetermined function in response to at least a portion of the received data. The method also includes transmitting data to the at least one computing resource from the at least one industrial device using the cloud communication network. The transmitted data is generated in response to performance of the at least one predetermined function.

Embodiments of an industrial device for communicating with a remote infrastructure environment having at least one computing resource and a cloud communication network are also disclosed herein. In one such embodiment, the device includes a network interface for establishing communication with a plant communication network and a controller. The controller is configured to receive data from the at least one computing resource and perform at least one predetermined function in response to at least a portion of the received data. The controller is also configured to transmit data to the at least one computing resource through the plant communication network. The transmitted data is generated in response to performance of the at least one predetermined function. The plant communication network is also operatively coupled to the cloud communication network to transfer the transmitted data.

### BRIEF DESCRIPTION OF THE DRAWINGS

The description herein makes reference to the accompanying drawings wherein like reference numerals refer to like parts throughout the several views, and wherein:

FIG. 1 is a schematic view of an industrial communication system;

FIG. 2 is a top plan view of an assembly line;

FIG. 3 is a schematic view of a robot; and

FIG. 4 is a schematic view of an end effector.

### DETAILED DESCRIPTION

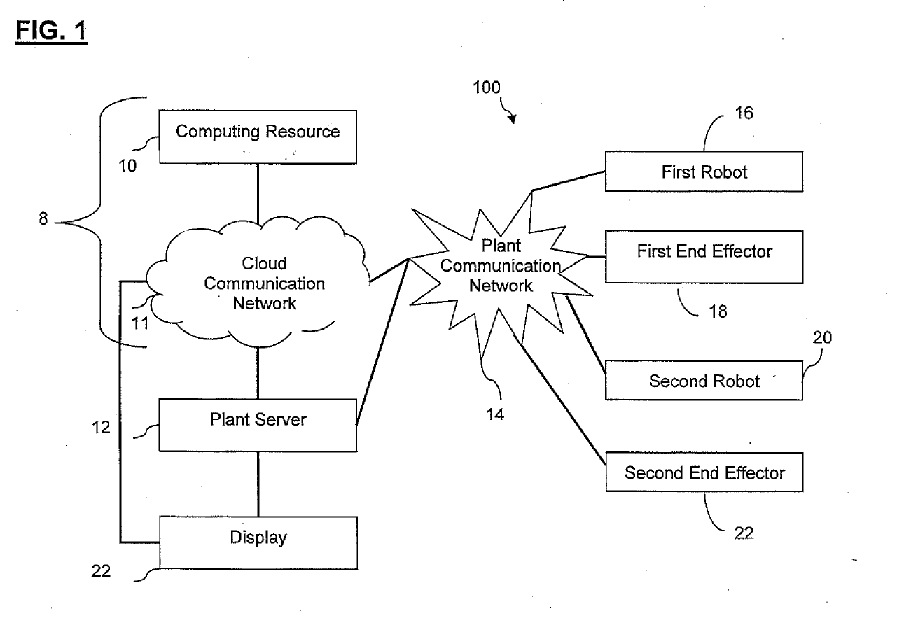

Examples of an industrial communication systems for communicating to industrial appliances are described herein with references to FIGS. 1-4. As shown in FIG. 1, an industrial communication system 100 can include a remote infrastructure environment 8 having one or more computing resources 10 and a cloud communication network (e.g. Internet) in communication with a plant server 12. The plant server 12 can be in communication via a plant communication network 14 (e.g. a local area network (LAN) with various industrial devices or appliances. For example, industrial devices or appliances can be a first robot 16, a first end effector 18, a second robot 20, a second end effector 22, and/or additional robots, end effectors or other industrial devices not shown in FIG. 1. Alternatively, or in addition to the plant server 12 being in communication with plant communication network 14, the industrial system 100 can be in direct communication with the cloud communication network 11 to send data to and/or receive data from the industrial appliances. Both the cloud communication network 11 and the plant server 12 can communicate data to visual and/or audible display 22.

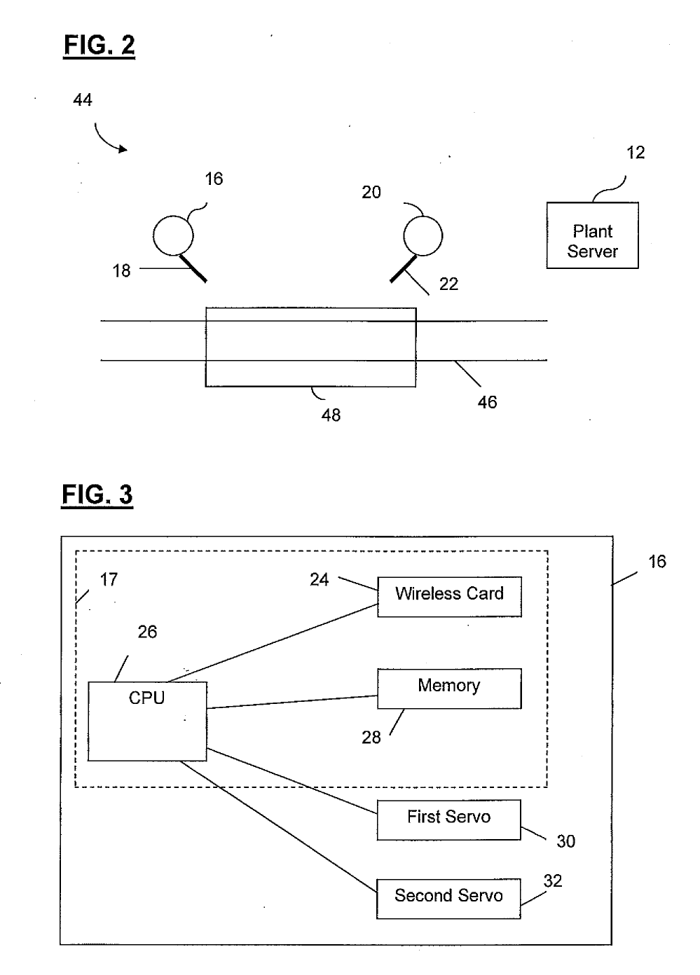

As shown in FIG. 2, a manufacturing plant 44 can include one or more assembly lines 46, each of which has one or more workstations 48 where work pieces (not shown) are processed. The industrial appliances, here the first robot 16, its first end effector 20, the second robot 18, and its second end effector 22, can be positioned sufficiently close to the assembly line 46 to process a work piece at the workstation 48. The plant server 12 can also be located within the manufacturing plant 44.

Referring back to FIG. 1, the computing resource 10 can be hardware, software or any combination thereof. In one embodiment, the cloud resource is a remote server including a microprocessor and memory with software stored thereon. The computing resource 10 can also be, as non-limiting examples, a PLC, a laptop computer, a desktop computer, a workstation, a handheld device, microprocessor, a storage database or any combination thereof. Of course, other cloud resources are available and other embodiments may use any other suitable device, combination of devices. Similar to the function of the PLC as described previously, the computing resource 10 can be used to control the operation of the industrial appliances such as the first robot 16, its first end effector 20, the second robot 18, and its second end effector 22.

Generally, conventional manufacturing plants use on-site PLCs to control the industrial appliances located therein. By some or all eliminating PLCs from the manufacturing plant 44 (i.e. PLCs that are physically located at the manufacturing plant), a manufacturing plant can, for example reduce costs by no longer having to provide and maintain the hardware (i.e. PLC) and software to programmed thereon to control the industrial appliances. Of course, in some embodiments, manufacturing plants 44 may still contain one or more PLCs controlling some industrial appliances whereas other appliances will be communicating with the remote infrastructure environment 8 without the use of a PLC.

Further, the elimination of some or all PLCs in a manufacturing plant can increase the plant's operating efficiency by having the capability to remotely control and communicate from the cloud communication network 11 to the industrial appliances. Further, the operating efficiency of the can also be increased by having the capability, as will be discussed in more detail below, to simultaneously talk to the robots and their associated end effectors (e.g. first robot 16 and end effector 18).

As discussed previously, the computing resource 10 can be in communication with the plant server 12 and/or the industrial appliances via, for example, the cloud communication network 11. The computing resource 10 and cloud communication network 11 may be based on a public, private, hybrid computing model or any other suitable computing model. In a public computing model, the computing resource 10 can be run or managed by a third party entity and made available to a group of unrelated or related customers, companies organizations and/or other entities. For example, in one public computing model, the computing resource 10 can be run or managed by a manufacturer of industrial appliances that supplies these appliances to different manufacturing plants. As such, the computing resource 10 (e.g. servers, storage systems, and network resources) can be shared by the customers and can used to communicate with industrial appliances in different and/or unrelated plants. However, for example, even in a public computing model, a particular plant may have its own private cloud resources, which may not be available for use by other plants.

In a private computing model, the computing resource 10 can be built for the exclusive use of one customer, organization or other entity. For example, in one private computing model, the computing resource 10 can be run or managed by a company owning multiple manufacturing plants. The private computing model can be hosted by the particular company itself or a third party entity. Private computing models permit a customer, organization or other entity to have a high level of control over the cloud resources 10.

The computing resource 10 may be located at any suitable location regardless of whether a public, private and hybrid computing model is employed. For example, the cloud resource, the computing resource 10 can be hosted at a location remote from a manufacturing plant or at the plant itself. As discussed previously, the cloud resource can be located at a facility operated by a manufacturer of industrial appliances or at a facility of a company owning multiple manufacturing plants. Of course, the computing resource 10 may be hosted at any other suitable location.

Although, as described previously, cloud communication network 11 may be the Internet, cloud communication network 11 may also be any other suitable communication protocol or infrastructure. For example, in other embodiments, cloud communication network 11 can be a virtual private network, a private network (e.g. Multiprotocol Label Switching), a point-to-point network or any other suitable network or any combination thereof.

Additionally, the computing resource 10 can be in communication with multiple plant servers 12, such as plant servers 12 located at different manufacturing plants or with the industrial appliances located at the different manufacturing plants. Similarly, more than one computing resource 10 can be in communication with a single plant server 12 or the industrial appliances. The memory of the computing resource 10 can be loaded with various types of information, such as operational instructions and software updates for one or more industrial appliance. Thus, the computing resource 10 can transmit information, such as industrial appliance software and/or maintenance updates and industrial appliance operating instructions, to the plant server 12. The computing resource 10 can also transmit this information directly to the industrial appliances. Additionally, the computing resource 10 can receive information from each plant server 12 or directly from the industrial appliances. Information received by the computing resource 10 from the plant server 12 or the industrial appliances can be used, as examples, to monitor the efficiency and condition of the industrial appliances.

The plant server 12 can be a server including a microprocessor and memory with software stored thereon. In addition to receiving information from the computing resource 10, the plant server 12 can receive information locally, such as by manually entering the information into the plant server 12, by uploading information to the plant server 12 using an information storage device such as a CD-ROM drive or a portable hard-drive, or by transferring information to the plant server 12 from a computer via the plant communication network 14. The plant server 12 can communicate information to/from the industrial appliances (e.g., the first robot 16, the first end effector 18, the second robot 20, and the second end effector 22) via the plant communication network 14 as is discussed below in greater detail.

As discussed previously, the plant communication network 14 can be a LAN and can include, as examples, one or more wireless routers for communication based on IEEE standard 802.11 (also known as Wi-Fi) and/or components such as hubs, routers, switches, bridges, and wires for communication based on IEEE standard 802.3 (also known as Ethernet). The plant communication network 14 can enable communication from the plant server 12 to the industrial appliances, such as the first robot 16, first end effector 18, second robot 20, and second end effector 22 as shown in FIG. 1. Also, instead of the LAN, another type of communication system can be used for communication between the plant server 12 and the industrial appliances, such as a CAN (Campus Area Network) if, for example, the manufacturing plant 44 is of sufficient size to warrant the use of the CAN.

Display 22 can provide information regarding information/data collected from or sent to the industrial appliances, status reports of the industrial appliances, maintenance management information any other information as desired or required. Display 22 can be located within the manufacturing plant 44 or at a location remote therefrom. Although only one display 22 is shown, the industrial communication system 100 many include more than one display or no displays as desired or required. The display 22 can be configured by a user to display all of the information related to industrial appliances in the manufacturing plant 44 (or other plants) or can be configured to display only a subset of that information. Of course, other suitable displays are available.

Known control systems for controlling robots and end effectors can have many drawbacks. For example, reprogramming each control system when changing end effectors or other changing the operation performed by the robot can be inefficient.

Embodiments described herein can have many advantages over known control systems for robots. For example, efficiency can be improved because an end effector can be programmed prior to installation on a robot. As another example, software updates, such as updates providing new instructions, can easily be communicated to robots and/or end effectors to enable an assembly line along which the robots and end effectors are positioned to be more efficiently reconfigured.

As shown in FIG. 3, the first robot 16 can include a robot control system 17, which can be coupled directly to the robot 16 (e.g., to a base, an arm, or a wrist of the robot 16) or can be disposed adjacent to the robot 16. The robot control system 17 can include a wireless card 24 for communication with the plant server 12 via the plant communication network 14. The robot control system (RCS) 17 can alternatively include another type of network interface card (NIC), such as an Ethernet card, depending on the configuration of the plant communication network 14. The wireless card 24 can be in communication with a CPU 26 for transmitting information received from the plant server 12 to the CPU 26. The CPU 26 can be a microprocessor, and the CPU 26 can be in communication with a memory 28. The memory 28 can be RAM, ROM, a hard-drive, or another type of memory. The CPU 26 can communicate information received from the wireless card 24 to the memory 28 for storage thereon. Additionally, the CPU 26 can retrieve information stored on the memory 28, and the CPU 26 can execute software stored on the memory 28. For example, the CPU 26 can execute a robot control program stored on the memory 28 and including instructions for controlling the robot 16 to move the end effector 18 into a predetermined position or along a predetermined path. Further, the RCS 17 can use its wireless card 24 to communicate with other devices, such as other industrial appliances, via the plant communication network 14.

Still referring to FIG. 3, the robot 16 can additionally include at least one servo, such as a first servo 30 and a second servo 32, for generating forces that move the robot 16. For example, activation of the first servo 30 can cause rotation of the robot 16 about its base, while activation of the second servo 32 can cause rotation of a wrist of the robot 16 relative to an arm of the robot 16. The CPU 26 of the RCS 17 can be in communication the servos 30 and 32. As a result, the RCS 17 can control the servos 30 and 32, thereby controlling movement of the robot 16. Additional servos can be included for additional movement of the robot 16 (e.g., the robot 16 can have six degrees of freedom and can have six servos, one corresponding to each degree of freedom), and the RCS 17 can be in communication with the additional servos to control operation of the additional servos. Further, the RCS 17 can be in communication with additional components not shown in FIG. 3, such as one or more sensors for detecting the position of the first robot 16. The second robot 20 can also include one of the RCSs 17 and at least one servo, such as servos 30 and 32.

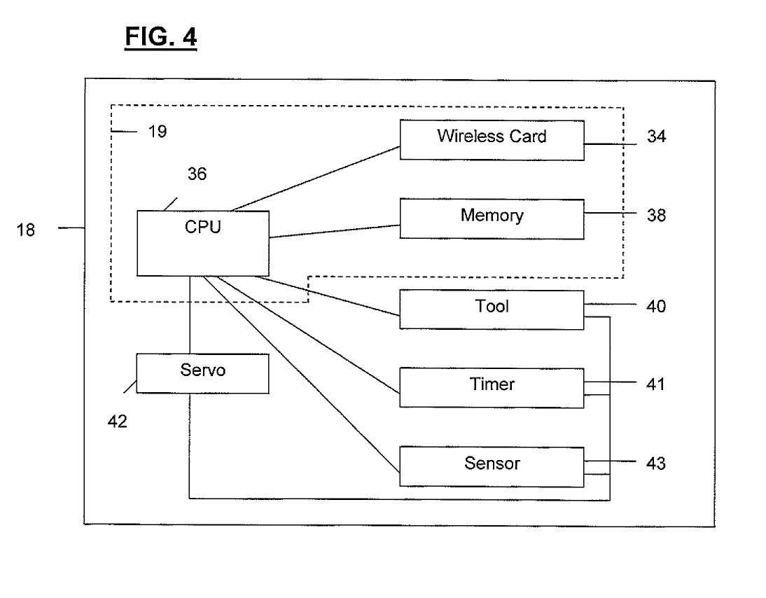

As shown in FIG. 4, the first end effector 18 can include an end effector control system or end effector control unit (EECU) 19. The first end effector 18 and the EECU 19 can be packaged together such that they form an integral unit. As example, the EECU 19 can be installed in a housing on an exterior of the end effector 18, or the EECU 19 can be housed within an exterior casing of the end effector 19. The EECU 19 can include a wireless card 34 for communication with the plant server 12 or the cloud communication network 11 via the plant communication network 14. The EECU 19 can alternatively include another type of network interface card (NIC), such as an Ethernet card, depending on the configuration of the plant communication network 14. The wireless card 34 can be in communication with a CPU 36 for transmitting information received from the plant server 12 to the CPU 36. The CPU 36 can be a microprocessor, and the CPU 36 can be in communication with a memory 38. The memory 38 can be RAM, ROM, a hard-drive, or another type of memory. The CPU 36 can communicate information received from the wireless card 34 to the memory 38 for storage thereon. Additionally, the CPU 36 can retrieve information stored on the memory 38, and the CPU 36 can run software stored on the memory 38. For example, the CPU 36 can execute an end effector control program stored on the memory 38 and including instructions for controlling the end effector 18. Further, the EECU 19 can communicate with other industrial appliances, such as the RCS 17, via the plant communication network 14.

Still referring to FIG. 4, the first end effector 18 can additionally include a tool 40. The tool 40 can be a device for operating on a work piece, such as a welding gun, a clamp, an adhesive applicator, a paint sprayer, or a stud welder. The EECU 19 can be in communication with the tool 40 to control the operation of the tool 40. The first end effector 18 can also include other components, such as one or more of a timer 41 for determining the duration of time that the tool 40 operates (alternatively, the CPU 36 can perform a timing function), one or more servos 42 for moving or actuating the tool 40, and one or more sensors 43 for detecting the operation of the tool 40. Depending on the type of tool 40, the sensor 43 can detect whether the tool 40 is in an “on” state or an “off” state, the progress of the tool 40 in performing an operation, the efficiency of the tool 40, and/or another status of the tool 40. Each of the timer 41, servo 42 and sensor 43 can be in communication with the CPU 36, and the CPU 36 can actuate the servo 42 to control the tool 40 in response to the end effector control program with input from the timer 41 and sensor 43. Depending on the type of tool 40, another tool actuating device can be included instead of or in addition to the servo 42. For example, a pneumatic device, a motor, a valve, and/or an electrical circuit for activating the tool 40 can be included instead of or in addition to the servo 42. The second end effector 22 can also include one of the EECUs 19 and other components such as the tool 40, timer 41, servo 42 and/or sensor 43.

Due to the inclusion of the EECU 19, as well as any of the timer 41, servo 42 and sensor 43 that are included, the first end effector 18 can be a self-contained unit that can control its own function. The end effector 18 can thus rely on the first robot 16 solely for positioning the end effector 18. The end effector 18 need not necessarily receive a control signal originating from a controller that also controls the robot 16. That is, separate and independently functioning control systems, the RCS 17 and the EECU 19 in the examples shown in FIGS. 2 and 3, can control the first robot 16 and the first end effector 18 carried by the first robot 16, respectively. Though the operation of the EECU 19 can be independent of the RCS 17 and the end effector 18 can rely on the robot 16 solely for positioning, it is also possible for the EECU 19 and RCS 17 to communicate with each other via the plant communication network 14 or other communication system as mentioned above. For example, the RCS 17 can communicate the position of the robot 16 and/or end effector 18 to the EECU 19, which can take the position of the robot 16 and/or end effector 18 into consideration when controlling the tool 40. Further, the RCS 17 and EECU 19 of the first robot 16 and first end effector 18 can communicate with industrial appliances other than each other, such as the RCS 17 and EECU 19 of the second robot 20 and second end effector 22. As a result, the RCS 17 and EECU 19 of the second robot 20 and second end effector 22, respectively, can control their respective industrial appliances based on input received from the RCS 17 and/or EECU 19 of the first robot 16 and first end effector 18, respectively.

Additionally, the plant server 12 can update software and operating instructions, among other information, on the memory 28 of the RCS 17 and the memory 38 of the EECU 19 by communicating with the RCS 17 and EECU 19 via the plant communication network 14. The plant server 12 can communicate independently with the each RCS 17 and EECU 19. Thus, different industrial appliances can be updated or receive new operating instructions independently from other industrial appliances, though different updates and new information can be transferred simultaneously to multiple industrial appliances. Communication between the plant server 12 and the robots 16 and 20 and end effectors 18 and 22 can be beneficial for multiple reasons. For example, new operating instructions can be provided if the assembly line 46 is reconfigured, such as by changing the operations performed by the robots 16 and 20 or their end effectors 18 and 22, respectively, to process a different type of work piece. As another example, instructions can be updated if a bug is discovered in a previous version of the instructions, or if one of the robots, robot 16 for example, malfunctions and an adjacent robot, robot 20 for example, can be reconfigured to perform the same operation via a robot control program update and/or end effector change.

Updating instructions on the robots 16 and 20 and/or end effectors 18 and 22 via the plant communication network 14 can also increase the efficiency of the manufacturing plant 44. For example, the end effector 18 can be programmed to perform a certain function prior to installation on the robot 16, such as if the end effector 18 is replacing a previous end effector. The end effector 18 can be reprogrammed while being transported to the robot 16 on an automated guided vehicle, or while in a storage facility. Thus, once the end effector 18 is installed, the robot 16 and end effector 18 can begin performing operations. Additionally, having the server 12 with the ability to control all robots 16 and 20 and end effectors 18 and 22 can increase the efficiency of the assembly line 44 because all control systems can be accessed from a single location (i.e., the server 12).

The above-described examples have been described in order to allow easy understanding of the invention and do not limit the invention. On the contrary, the invention is intended to cover various modifications and equivalent arrangements, whose scope is to be accorded the broadest interpretation so as to encompass all such modifications and equivalent structure as is permitted under the law.

1. A method for controlling at least one industrial device using a remote infrastructure environment having at least one computing resource and a cloud communication network, the method comprising:
establishing communication between the at least one industrial device and the remote infrastructure environment;
transmitting data from the at least one computing resource to a plant communication network using the cloud communication network, the at least one industrial device configured to perform at least one predetermined function in response to at least a portion of the transmitted data; and
receiving data by the at least one computing resource from the at least one industrial device using the cloud communication network, the received data generated in response to performance of the at least one predetermined function.

2. The method of claim 1, wherein performance of the at least one predetermined function is completed without the use of an on-site programmable logic controller.

3. The method of claim 1, wherein the transmitted data includes maintenance updates for the at least one industrial device.

4. The method of claim 1, wherein the cloud communication network is one of an Internet network, a point-to-point network and a private network.

5. The method of claim 1, wherein transmitting data includes transmitting data through an on-site plant server.

6. The method of claim 1, wherein the at least one industrial device is one of a robot and an end effector.

7. The method of claim 1, wherein the plant communication network is a local area network.

8. The method of claim 1, wherein the at least one computing resource is at least one of a remote server, a remote PLC, a remote handheld device, a remote microprocessor and a remote storage database.

9. A method for communicating with at least one industrial device using a remote infrastructure environment having at least one computing resource and a cloud communication network, the method comprising:
establishing communication between the at least one industrial device and the remote infrastructure environment;
receiving data by the at least one industrial device from the at least one computing resource using a plant communication network performing at least one predetermined function in response to at least a portion of the received data; and
transmitting data to the at least one computing resource from the at least one industrial device using the cloud communication network, the transmitted data generated in response to performance of the at least one predetermined function.

10. The method of claim 9, wherein performing the at least one predetermined function includes:
performing the at least one predetermined function without the use of an on-site programmable logic controller.

11. The method of claim 9, further comprising:
providing the industrial device with one of maintenance updates and software updates, the maintenance updates and software updates transmitted from the at least one computing resource.

12. The method of claim 9, wherein the cloud communication network is one of an Internet network, a point-to-point network and a private network.

13. The method of claim 9, wherein receiving data includes receiving data through an on-site plant server.

14. The method of claim 9, wherein the at least one industrial device is one of a robot and an end effector.

15. The method of claim 9, wherein the plant communication network is a local area network.

16. An industrial device for communicating with a remote infrastructure environment having at least one computing resource and a cloud communication network, the device comprising:
a network interface for establishing communication with a plant communication network; and
a controller configured to:
receive data from the at least one computing resource;
perform at least one predetermined function in response to at least a portion of the received data; and
transmit data to the at least one computing resource through the plant communication network, the transmitted data generated in response to performance of the at least one predetermined function;
wherein the plant communication network is operatively coupled to the cloud communication network to transfer the transmitted data.

17. The device of claim 16, wherein the control is configured to perform the at least one predetermined function without the use of an on-site programmable logic controller.

18. The device of claim 16, wherein the controller is further configured to:
receive at least one of maintenance updates and software updates from the at least one computing resource.

19. The device of claim 16, wherein the cloud communication network is one of an Internet network, a point-to-point network and a private network.

20. The device of claim 16, wherein receiving data includes receiving data through an on-site plant server.
